(19) United States
(12) Patent Application Publication
(10) Pub. No.: US 2015/0084525 A1
(43) Pub. Date: Mar. 26, 2015

(54) ADJUSTABLE CONTROL FOR BI-LEVEL LUMINAIRE DRIVER

(71) Applicant: MAXLITE, INC., West Caldwell, NJ (US)

(72) Inventor: James Steedly, Menifee, CA (US)

(21) Appl. No.: 14/495,395

(22) Filed: Sep. 24, 2014

Related U.S. Application Data
(60) Provisional application No. 61/881,517, filed on Sep. 24, 2013.

(51) Int. Cl. H05B 33/08

(52) U.S. Cl. CPC H05B 33/0854; H05B 33/0812
USPC 315/158

(57) ABSTRACT

An adjustable bi-level lighting control is for use in connection with LED luminaires having an LED, a current control circuit, a driver circuit and an AC source. The LED luminaire is directed to illuminate an area having intermittent occupancy. The adjustable bi-level lighting control comprises a dimmer supplying a first control signal to the current control circuit, to control current flow to the LED. An occupancy sensor, responsive to an occupant entering the area, supplies a second electrical control signal to the dimmer. An adjustable control connected to the dimmer allows for selective adjustment of the first electrical control signal. Low and high level potentiometers selectively adjust the first electrical control signal to low and high levels, thereby selectively adjusting the LED to low and high levels of intensity, respectively.

### CROSS-REFERENCE TO RELATED APPLICATION

This application claims priority to U.S. Provisional Patent Application No. 61/881,517, filed Sep. 24, 2013, the entire contents of which are incorporated by reference herein.

### FIELD OF THE INVENTION

This invention relates to luminaires and, more particularly, to a bi-level driver for both LED and fluorescent luminaires that has a field adjustable control.

### BACKGROUND OF THE INVENTION

Bi-level lighting controls save energy by dimming light levels when areas are unoccupied. Bi-level light fixtures include bi-level LED drivers, or fluorescent bi-level ballasts, and are controlled by passive infrared (PIR) sensors, ultrasonic sensors, and photo-sensitive occupancy sensors. When there is no activity in the area, lights are set to a lower level of illumination, for example from 10% to 50% of full lighting. When the occupancy sensors are activated, lighting intensity increases, for example, from 80% to 100% until the area is unoccupied for a predetermined time period, at which point the illumination decreases to the previous low level.

Parking facilities are suitable candidates for bi-level lighting due to long periods of no autos or people in motion. It is common for parking lots and garages to have lights on all day or all night, regardless of the lighting need. Other candidates for bi-level lighting include low-occupancy areas such as stairwells, storerooms, restrooms and perimeter lights.

Bi-level streetlamp fixtures decrease maintenance costs by reducing the frequency of lamp burnouts. Bi-level lighting can increase safety and security in several ways. Increases in lighting intensity alert drivers and pedestrians to approaching traffic. Higher color temperatures may increase visual acuity.

Stairwell light fixtures with a dimming or switching controller allow energy savings. The fixture operates at a constant low light level (energy-saving mode) e.g., about 1 foot-candle. When an integral or separately mounted occupancy sensor detects that a person has entered the space, it signals the controller to raise light level to code-compliant full brightness (occupied mode) e.g., 10 foot-candles. Some products provide complete shutoff capability for when codes allow it.

The result is up to 70-80% energy savings. The energy savings may have two components. First, the existing fixture may be T12 and replaced with a more-efficient electronic-ballasted T8, T5 or T5HO (or LED) fixture. Second, the occupancy sensor ensures that the lights maintain a lower light level during the majority of the time the stairwell is unoccupied.

Stairwell fixtures are available in various lamp lengths and wattages; white or clear prismatic lens; and wall or ceiling mounting. The controller may offer step dimming (single ballast), continuous dimming (single ballast) or bi-level switching (two ballasts) capability, with a choice of low-end light level. The occupancy sensor is either mounted as a part of the fixture or separately with wireless communication between the sensor and the controller, and detects occupancy via passive-infrared (PIR) or ultrasonic technology. Adjustable time delay and emergency battery backup options are typically available. Some products contain a light sensor that maintains the low light level setting during occupancy if there is a high enough light level on the stairs due to daylight contribution from windows and skylights.

One problem that the prior art bi-level lighting controls often fail to solve is to ensure that the lights rise to full output during occupancy. This requires avoiding sensor “blind spots” and ensuring that the sensor is sensitive enough to raise light output immediately upon occupancy. In the case of a PIR sensor, the sensor must have a line of sight between the sensor and the occupant, and is most sensitive to people moving laterally in front of the sensor. Ultrasonic sensors are more sensitive, do not require a line of sight, and are most sensitive to people moving toward and away from the sensor. Wireless sensors enable more flexibility in placement, as they are not tied to a specific fixture location. The present invention solves this problem with a field adjustable dimmer that allows the luminosity to be adjusted for the area geometry and ambient light levels.

In addition to the savings achieved with bi-level controls, significant energy and lifecycle cost savings can also be realized by replacing old light fixtures with energy efficient fixtures such as LED, induction, and fluorescent. Modern luminaires and bi-level controls can create both peak demand reductions (kW) and hourly energy use reductions (kWh). Typical energy savings for parking lots and garages retrofitted with bi-level lighting are 20%-70% depending on age of equipment.

Since most office workers today are using computers the majority of the time, there is diminished need for higher levels of ambient lighting. Bi-level controls bring the lighting level up to half intensity when occupancy is detected. The other half of the lighting intensity can be brought on manually as needed for more detailed work or for visitors. This system requires that the office be wired for bi-level lighting.

Prior art drivers have predetermined default values, for example, they could dim down to 10% and up to 80%. One drawback to prior art bi-level lighting controls is that these default values are set at the factory, and typically cannot be changed in the field. It would be advantageous to be able to adjust lighting parameters in the field to suit the geometry and traffic flow of the particular installation.

There is a need, therefore, for an adjustable bi-level lighting control for LED luminaires that will allow upper and lower limits of lighting intensity to be field adjusted.

There is a further need for an adjustable bi-level lighting control for LED luminaires as described, and that will allow lighting intensity to be field adjusted to suit the geometry and traffic flow of the area.

There is a further need for an adjustable bi-level lighting control for LED luminaires as described, and that exhibits a long service life.

There is a yet further need for an adjustable bi-level lighting control for LED luminaires as described, and that can be installed quickly and easily.

There is a still further need for an adjustable bi-level lighting control for LED luminaires as described, and that can be manufactured in large quantities of high quality, and in a cost-effective manner.

### SUMMARY

An adjustable bi-level lighting control for LED luminaires constructed in accordance with the invention is shown at 210. The dimmer control 222 is used in connection with an LED luminaire 212. The luminaire has an LED 214, a current control circuit 216 supplying electrical power to the LED 214, and a driver circuit 218 supplying electrical power to the current control circuit 216. An AC source 220, having a voltage of 120v-240v or 277v, supplies electrical power to the driver circuit 218.

The LED luminaire 212 is directed to illuminate an area having intermittent occupancy. The adjustable bi-level lighting control comprises a dimmer 224 operatively connected to the current control circuit 216 to supply a first electrical control signal to the current control circuit 216, thereby to control current flow to the LED 214.

An occupancy sensor 226, responsive to an occupant entering the area, is operatively connected to the dimmer 224 to supply a second electrical control signal to the dimmer 224. The occupant can be a person or a car entering the area.

An adjustable control 228 is operatively connected to the dimmer 224, and allows for selective adjustment of the first electrical control signal. The adjustable control 228 can be a variable resistor, capacitor, or inductor, and is preferably a potentiometer. A low level potentiometer is provided to selectively adjust the first electrical control signal to a low level. The LED is thereby selectively adjusted to a low level of intensity. A high level potentiometer is provided to selectively adjust the first electrical control signal to a high level. The LED is thereby selectively adjusted to a high level of intensity.

### BRIEF DESCRIPTION OF THE DRAWINGS

FIG. 1 is a flow chart of a prior art driver for LED luminaires.

FIG. 2 is a flow chart of a prior art driver with bi-level lighting control for LED luminaires.

FIG. 3 is a flow chart of an adjustable bi-level lighting control and driver for LED luminaires constructed in accordance with the invention.

### DETAILED DESCRIPTION OF THE INVENTION

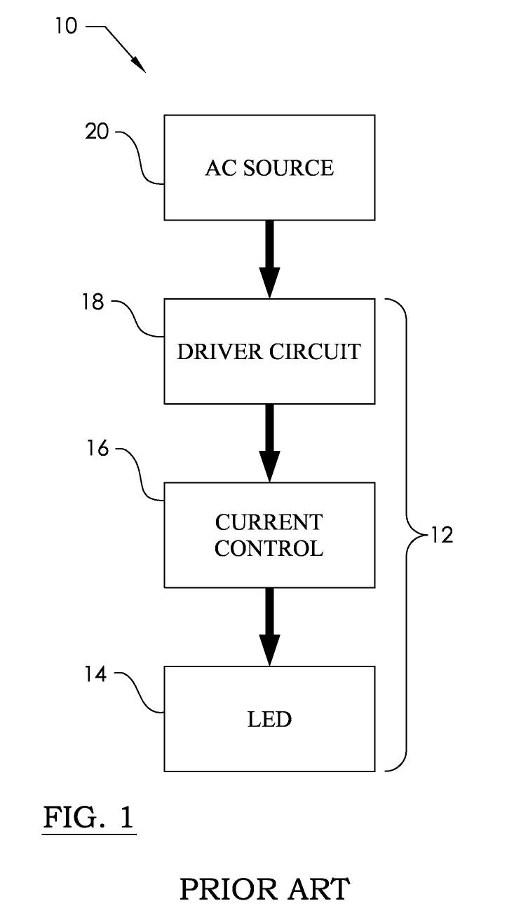

Referring to FIG. 1, a prior art LED luminaire is shown at 10. The luminaire has an LED 14, a current control circuit 16 supplying electrical power to the LED 14, and a driver circuit 18 supplying electrical power to the current control circuit 16. An AC source 20 supplies electrical power to the driver circuit 18. The AC source electrical power typically has a voltage of 120v-240v or 277v.

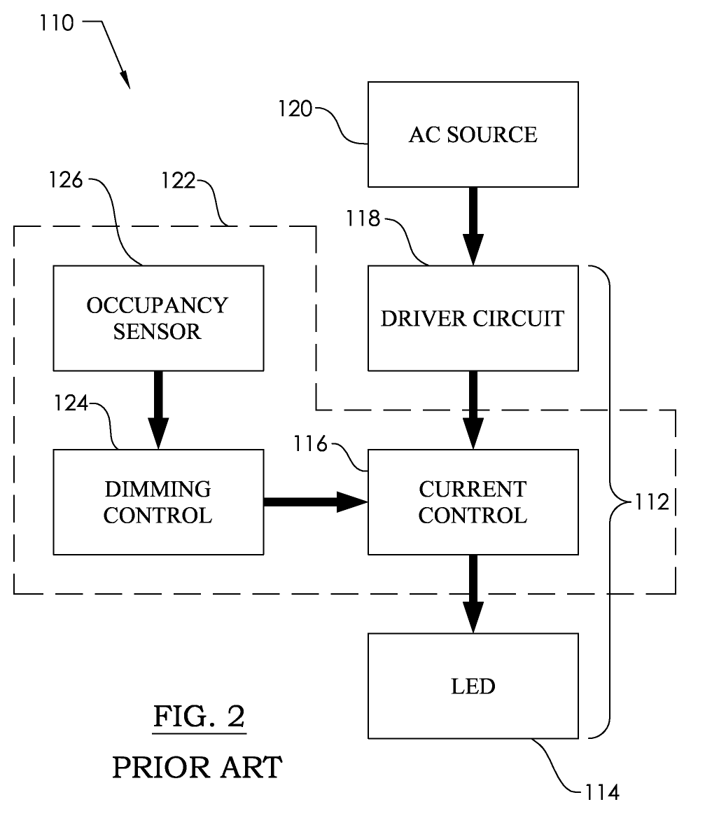

Referring to FIG. 2, a prior art bi-level lighting control for LED luminaires is shown at 110. The dimmer control 122 is used in connection with an LED luminaire 112. The luminaire has an LED 114, a current control circuit 116 supplying electrical power to the LED 114, and a driver circuit 118 supplying electrical power to the current control circuit 116. An AC source 120 supplies electrical power to the driver circuit 118 The AC source electrical power typically has a voltage of 120v-240v or 277v.

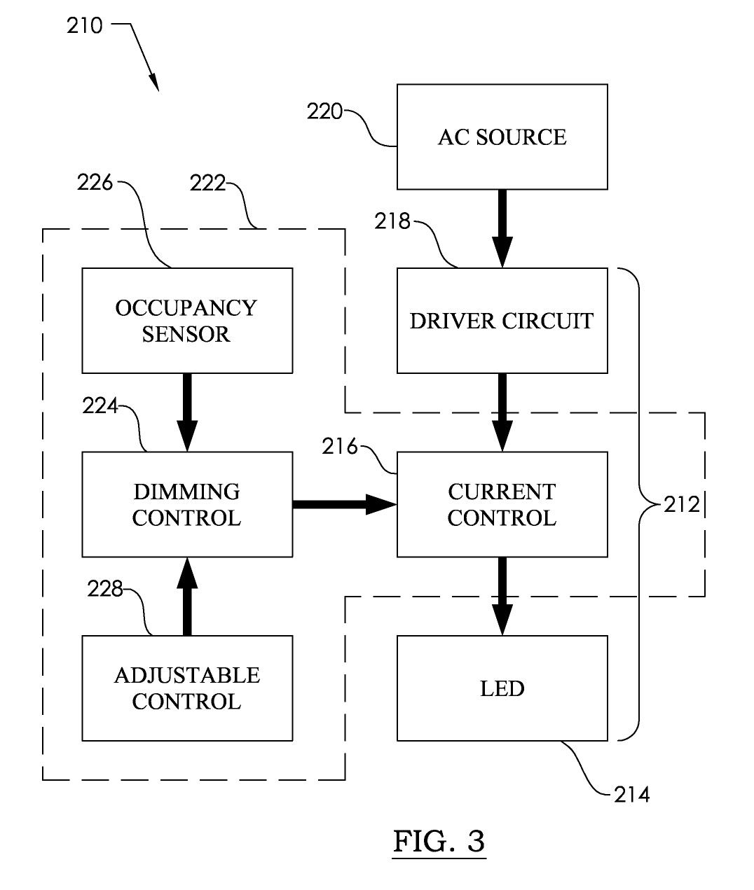

Turning now to FIG. 3, an adjustable bi-level lighting control for LED luminaires constructed in accordance with the invention is shown at 210. The dimmer control 222 is used in connection with an LED luminaire 212. The luminaire has an LED 214, a current control circuit 216 supplying electrical power to the LED 214, and a driver circuit 218 supplying electrical power to the current control circuit 216. An AC source 220 supplies electrical power to the driver circuit 218. The AC source electrical power typically has a voltage of 120v-240v or 277v, but any power source can be used.

The LED luminaire 212 is directed to illuminate an area, such as a parking garage, a staircase, an office, a streetlamp, or any space having intermittent occupancy. The adjustable bi-level lighting control comprises a dimmer 224 operatively connected to the current control circuit 216. The dimmer 224 is adapted to supply a first electrical control signal to the current control circuit 216 to control current flow to the LED 214.

An occupancy sensor 226 is operatively connected to the dimmer 224. The occupancy sensor 226 supplies a second electrical control signal to the dimmer 224. The occupancy sensor 226 is responsive to an occupant entering the area. The occupant can be a person entering a room or stairwell or parking garage. The occupant can also be a car entering a parking garage.

An adjustable control 228 is operatively connected to the dimmer 224. The adjustable control 228 allows for selective adjustment of the first electrical control signal. The adjustable control 228 can comprise a variable resistor, a variable capacitor, a variable inductor, or any means for adjusting electrical parameters. While the adjustable control 228 described herein is preferably a potentiometer, the present invention includes any and all means for adjusting electrical parameters that fall within the spirit and scope of the claims. In the preferred embodiment, two potentiometers are employed. A low level potentiometer is provided to selectively adjust the first electrical control signal to a low level. The LED is thereby selectively adjusted to a low level of intensity indirectly by turning the low level potentiometer knob. A high level potentiometer is provided to selectively adjust the first electrical control signal to a high level. The LED is thereby selectively adjusted to a high level of intensity indirectly by turning the high level potentiometer knob. Alternatively, only one potentiometer can be employed, and would adjust the high level of intensity, leaving the low level set at factory default.

A method is disclosed for adjusting a bi-level lighting control. The method is for use in connection with an LED luminaire directed to illuminate an area, as described above. The method comprises first providing a dimmer, and operatively connecting the dimmer to the current control circuit, and then supplying a first electrical control signal to the current control circuit with the dimmer. The next step is controlling current flow to the LED with the first electrical control signal, and then controlling light output intensity of the LED by controlling current flow to the LED. The next step is providing an occupancy sensor, and operatively connecting the occupancy sensor to the dimmer. An additional step is supplying a second electrical control signal to the dimmer with the occupancy sensor, in response to an occupant entering the area. The next step is providing an adjustable control, and then operatively connecting the adjustable control to the dimmer. The last step is selectively adjusting the first electrical control signal with the adjustable control.

Further implementation of the method includes first supplying a high level second electrical control signal to the dimmer with the occupancy sensor, in response to the occupant entering the area. Next, switching the first electrical control signal to a high level first electrical control signal in response to the high level second electrical control signal. A last step is switching the light output intensity of the LED to a high level intensity in response to the high level first electrical control signal.

The method yet further includes first supplying a low level second electrical control signal to the dimmer with the occupancy sensor, in response to the occupant leaving the area. Next, switching the first electrical control signal to a low level first electrical control signal in response to the low level second electrical control signal. A last step is switching the light output intensity of the LED to a low level intensity in response to the low level first electrical control signal.

The method still further includes providing at least one variable resistor as an adjustable control. The variable resistor further comprises providing a low level potentiometer, and providing a high level potentiometer.

Another step in the method comprises selectively adjusting the first electrical control signal to an adjusted low level first electrical control signal with the low level potentiometer. The next step is adjusting a low level intensity of the LED with the adjusted low level first electrical control signal. Yet another step is selectively adjusting the first electrical control signal to an adjusted high level first electrical control signal with the high level potentiometer. Finally, adjusting a high level intensity of the LED with the adjusted high level first electrical control signal.

Yet another step in the method is providing at least one variable capacitor as the adjustable control. A last step is providing at least one variable inductor as the adjustable control.

What is claimed is:

1. An adjustable bi-level lighting control for use in connection with an LED luminaire directed to illuminate an area, the luminaire having an LED, a current control circuit supplying power to the LED, a driver circuit supplying power to the current control circuit, and an AC source supplying power to the driver circuit, the adjustable bi-level lighting control comprising:
a dimmer operatively connected to the current control circuit, the dimmer being adapted to supply a first electrical control signal to the current control circuit so as to control current flow to the LED;
an occupancy sensor operatively connected to the dimmer, the occupancy sensor being adapted to supply a second electrical control signal to the dimmer, the occupancy sensor being responsive to an occupant entering the area; and
an adjustable control operatively connected to the dimmer, the adjustable control being adapted to selectively adjust the first electrical control signal.

2. The adjustable bi-level lighting control of claim 1, wherein the adjustable control further comprises at least one variable resistor.

3. The adjustable bi-level lighting control of claim 2, wherein the variable resistor further comprises:
a low level potentiometer adapted to selectively adjust the first electrical control signal to a low level, thereby selectively adjusting a low level intensity of the LED; and
a high level potentiometer adapted to selectively adjust the first electrical control signal to a high level, thereby selectively adjusting a high level intensity of the LED.

4. The adjustable bi-level lighting control of claim 1, wherein the adjustable control further comprises at least one variable capacitor.

5. The adjustable bi-level lighting control of claim 1, wherein the adjustable control further comprises at least one variable inductor.

6. A method for adjusting a bi-level lighting control for use in connection with an LED luminaire directed to illuminate an area, the luminaire having an LED, a current control circuit supplying power to the LED, a driver circuit supplying power to the current control circuit, and an AC source supplying power to the driver circuit, the method comprising:
providing a dimmer;
operatively connecting the dimmer to the current control circuit;
supplying a first electrical control signal to the current control circuit with the dimmer;
controlling current flow to the LED with the first electrical control signal;
controlling light output intensity of the LED by controlling current flow to the LED;
providing an occupancy sensor;
operatively connecting the occupancy sensor to the dimmer;
supplying a second electrical control signal to the dimmer with the occupancy sensor, in response to an occupant entering the area;
providing an adjustable control;
operatively connecting the adjustable control to the dimmer; and
selectively adjusting the first electrical control signal with the adjustable control.

7. The method of claim 6, further comprising:
supplying a high level second electrical control signal to the dimmer with the occupancy sensor, in response to the occupant entering the area;
switching the first electrical control signal to a high level first electrical control signal in response to the high level second electrical control signal;
switching the light output intensity of the LED to a high level intensity in response to the high level first electrical control signal;
supplying a low level second electrical control signal to the dimmer with the occupancy sensor, in response to the occupant leaving the area;
switching the first electrical control signal to a low level first electrical control signal in response to the low level second electrical control signal; and
switching the light output intensity of the LED to a low level intensity in response to the low level first electrical control signal.

8. The method of claim 6, wherein providing an adjustable control further comprises providing at least one variable resistor.

9. The method of claim 8, wherein providing at least one variable resistor further comprises:
providing a low level potentiometer; and
providing a high level potentiometer.

10. The method of claim 9, further comprising:
selectively adjusting the first electrical control signal to an adjusted low level first electrical control signal with the low level potentiometer;
adjusting a low level intensity of the LED with the adjusted low level first electrical control signal;
selectively adjusting the first electrical control signal to an adjusted high level first electrical control signal with the high level potentiometer; and
adjusting a high level intensity of the LED with the adjusted high level first electrical control signal.

11. The method of claim 6, wherein providing an adjustable control further comprises providing at least one variable capacitor.

12. The method of claim 6, wherein providing an adjustable control further comprises providing at least one variable inductor.
